(19) United States
(12) Patent Application Publication
(10) Pub. No.: US 2012/0271610 A1
(43) Pub. Date: Oct. 25, 2012

(54) STOCHASTIC SIMULATION OF MULTI-LANGUAGE CONCURRENT SYSTEMS

(75) Inventors: Andrew Nicholas John Brojer Phillips, London (GB); Matthew Richard Lakin, Cambridge (GB)

(73) Assignee: Microsoft Corporation, Redmond, WA (US)

(21) Appl. No.: 13/091,950

(22) Filed: Apr. 21, 2011

(51) Int. Cl. G06G 7/48

(52) U.S. Cl. 703/11; 703/6

(57) ABSTRACT

A common framework provides for concurrently simulating a broad range of modeling languages with an arbitrary stochastic simulation method. The common framework is instantiated to each modeling language by defining a species function and a reactions function. The species function converts a model of the modeling language to a set of species, and the reactions function computes a set of possible reactions from a given set of species. The common framework is instantiated to a particular simulation method by defining three functions: one for computing the next reaction, another for computing the reaction activity from an initial set of reactions and species populations, and another for updating the reaction activity as the species populations change over time. Accordingly, the common framework compiles a set of species and possible reactions, dynamically updates the set of possible reactions, and selects the next reaction in an iterative cycle.

### BACKGROUND

Models of concurrent systems often involve large numbers of components with complex, highly parallel interactions and intrinsic stochasticity. Such models are becoming increasingly important to research and development in a variety of fields. For example, models of biological systems may be used within the pharmaceutical and medical industries to identify potential causes and methods of treatment for different forms of disease, and models of distributed systems may be used within the communications industry to analyze the performance of heterogeneous computer networks in the presence of varying network failures and delays.

To model the complexity of concurrent systems, numerous modeling languages have been developed, many of which can generate potentially unbounded numbers of different types of components (e.g., species in biological applications) and interactions (e.g., reactions in biological applications) involving these components. As a result, such modeling languages tend not to rely on standard stochastic simulation methods, which employ a fixed number of component types and interactions. Instead, each modeling language is typically implemented using a custom stochastic simulation method developed specifically for each modeling language. The custom stochastic simulation method is generally developed depending on the nature of the simulation. For example, the custom stochastic simulation method may be developed based on whether an exact simulation is required, whether certain reactions operate at different timescales, or whether non-Markovian reaction rates are used. Unfortunately, because each modeling language is implemented using its own custom stochastic simulation method, multiple models of concurrent systems written in different modeling languages are traditionally unable to interact with each other within a single simulation.

### SUMMARY

Implementations described and claimed herein address the foregoing problems by providing a common framework for concurrently simulating a broad range of models in different modeling languages with an arbitrary stochastic simulation method. The common framework supports a range of modeling languages and may be instantiated to use a range of stochastic simulation methods. The common framework is instantiated to each particular modeling language by defining a species function and a reactions function. The species function converts a model in the modeling language to a set of species, and the reactions function computes a set of possible reactions from a given set of species. The common framework is also instantiated to a particular simulation method by defining three functions: one for computing the next reaction, another for computing the reaction activity from an initial set of reactions and species populations, and another for updating the reaction activity as the species populations change over time. Accordingly, the common framework compiles a set of species and possible reactions, dynamically updates the set of possible reactions, and selects the next reaction in an iterative cycle. Multiple languages can be simulated concurrently to produce a multi-language environment for the simulation of heterogeneous models.

Further, a proof method may be used to prove that an instantiation of the common framework with a given modeling language is correct with respect to the specified behavior of the modeling language.

In some implementations, articles of manufacture are provided as computer program products. One implementation of a computer program product provides one or more tangible computer program storage media readable by a computing system and encoding a processor-executable program. Other implementations are also described and recited herein.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an example common framework for concurrently simulating multiple biological models written in different languages.

FIG. 2 illustrates an example common framework for performing a stochastic simulation of multi-language models.

FIG. 3 illustrates example operations for generating a multi-language environment for the simulation of multi-language models.

FIG. 4 illustrates an example system that may be useful in implementing the described technology.

### DETAILED DESCRIPTION

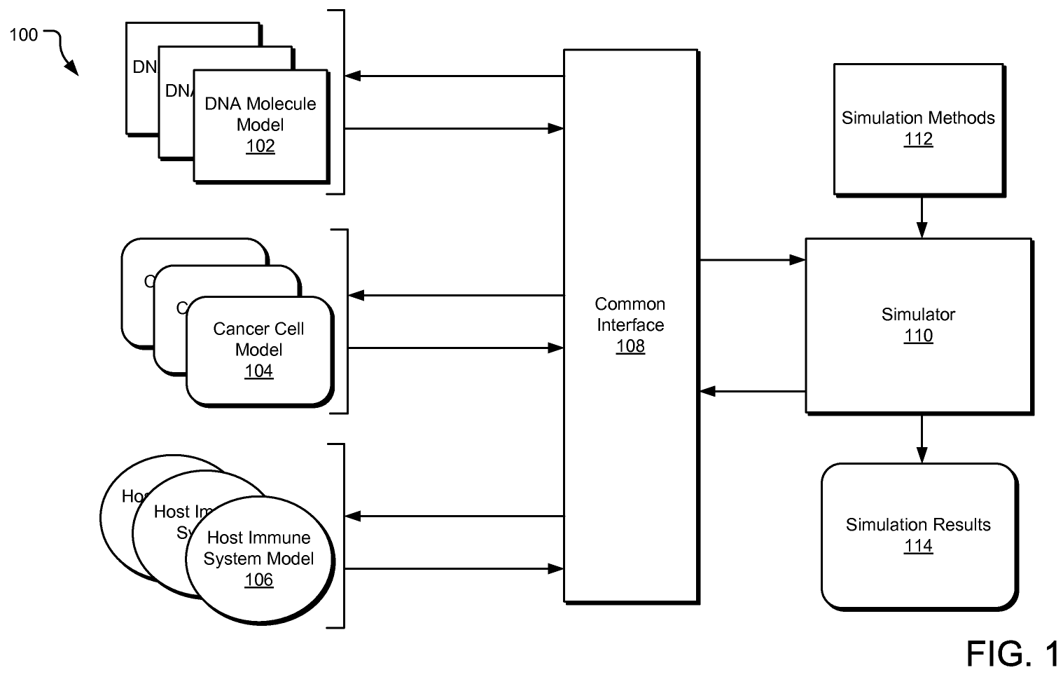

FIG. 1 illustrates an example common framework 100 for concurrently simulating multiple biological models written in different languages. Each model defines a type of component representing a particular biological domain (e.g., cancer cells, DNA molecules, etc.) Such multi-language biological models are examples of multi-language models of concurrent systems, although the described technology may be applied to models of other concurrent systems. Generally, concurrent systems include components that are simulated concurrently. In some concurrent systems, individual components can interact during the simulation. The common framework 100 includes biological models 102, 104, and 106 that are each written in a modeling language applicable to particular possible biological domains. A domain represents a particular area of interest depending on the problem to be simulated. Example modeling languages include without limitation variants of pi-calculus, BlenX, the Kappa calculus, the language for biochemical systems (LBS), variants of the bioambient calculus, DNA strand displacement (DSD), and Generic Engineering of Cells (GEC). The components of the biological models 102, 104, and 106 interact according to defined rules, which are articulated by the corresponding modeling language. For example, the DNA molecule model 102 may interact, for example, via DNA strand displacement; the cancer cell model 104 may interact by evolving through growing and dividing; and the host immune system model 106 may interact by checking for the presence of foreign bodies and defending against those foreign bodies.

A common interface 108 instantiates the common framework 100 to encode the biological models 102, 104, and 106 and to use a range of stochastic simulation methods. The simulator 110 operates as a compiler that uses the common interface 108 to dynamically update a set of possible reactions and choose the next reaction in an iterative cycle. Furthermore, within the common framework 100, the simulation of biological models 102, 104, and 106 receives cross-domain feedback from the common interface 108. For example, the simulation of the DNA molecule model 102 may form a vaccine that disrupts the evolution of the simulation of the cancer cell model 104, and the disruption of the cancer cell model 104 evolution triggers a response by the host immune system model 106. The results of the simulation run in the simulator 110 are output as simulation results 112, which may be presented in a graphical user interface, data readout, data stream, etc.

In one implementation, the biological models 102, 104, and 106 are written in different modeling languages. Examples of such modeling languages may include: the DNA molecule model 102 written in the DSD language, which can be used to model DNA circuits; the cancer cell model 104 written in the GEC language, which can be used to model genetic devices; and the host immune system model 106 written in the Stochastic Pi Machine (SPiM) language, which can be used for the general modeling of biological systems. However, other modeling languages, such as the bioambient calculus or the kappa calculus, may be used to define the biological models 102, 104, and 106. The common framework 100 may be instantiated to a broad range of modeling languages selected based on the problem to be simulated. Accordingly, a researcher can choose individual modeling languages best-suited for modeling each domain of a concurrent system of interest. Furthermore, the common framework 100 allows these domains to be simulated concurrently and interactively with the same simulation.

The common framework 100 is instantiated to a particular modeling language by defining a species function and a reactions function for each language. The species function converts a model of the language into a set of species, and the reactions function computes a set of possible reactions between the species. For each language, the semantics of the language itself can be used to derive the corresponding reactions function.

To derive the reactions function for a modeling language, the language is defined by formal syntax and corresponding semantics. For example, the syntax of the DSD language for the DNA molecule model 102 defines a set of possible configurations of DNA molecules. To construct the basic syntax of a modeling language, language constructs may be used to abstract away from the underlying processes that occur in a physical implementation. For example, a domain of the DSD language for the DNA molecule model 102 represents a nucleotide sequence with explicit information about its orientation, and a domain sequence of the DSD language for the DNA molecule model 102 is a concatenation of finite domains with the same orientation.

The semantics of a language formalize the various ways the components of a model of the language, such as the biological model 102, 104, or 106, can interact with each other by defining a set of reduction rules. The reduction rules are of the form

D [symbol] D′

which states that a model D can reduce to a model D′ by performing a reaction with a finite rate r according to rule R. Further, reduction rules may account for the variety of contexts in which a particular reaction could occur. For example, with respect to the DNA molecule model 102, a reaction could occur midway along a larger DNA molecule. To derive a complete single-step reduction relation for individual reactions, the context rules are used to formalize the different contexts. Additionally, the set of reduction rules may be extended, as required, to incorporate additional assumptions about the nature of the reactions. For example, the DSD language of the DNA molecule model 102 may contain the assumption that two single-stranded DNA molecules can only interact with each other via complementary toeholds. Other reduction rules may also be employed.

Each language may be equipped with multiple semantic interpretations that abstract away some of the complexity of the reactions by parameterizing the semantics of the language. For example, one implementation abstracts away specific behaviors when the behaviors increase the computational cost of the analysis without significantly increasing the accuracy. Examples of such behaviors include without limitation unproductive reactions, leak reactions, and fast reactions. Unproductive reactions do not contribute meaningfully to the progress of a simulation. An unproductive reaction for the DNA molecule model 102, for example, may be where a DNA strand binds to a gate along a short domain but cannot initiate any subsequent migration or displacement reactions. Leak reactions represent a form of unwanted interference between components, such as DNA molecules, which may have a significant impact on the behavior of the biological model. However, allowing leaks may dramatically increase the computational cost of the analysis. Fast reactions occur on a significantly faster timescale than other reactions in a biological model. The definition of which reactions constitute fast reactions depends on the selected semantic abstraction. To simplify and improve the efficiency of simulation, fast reactions may be abstracted away. In one implementation, fast reactions are abstracted away by treating the fast reactions as if they occurred instantaneously. In another implementation, fast reactions are abstracted away by merging the fast reactions into a single step with a fixed reaction rate. Accordingly, the accuracy of the biological models 102, 104, and 106 may be balanced with the computational cost of model analysis. Parameterizing the semantics of a language results in a hierarchy of semantics for the language, allowing the biological models 102, 104, and 106 to be formalized once and analyzed under a variety of behavioral assumptions. The reactions function for each of the biological models 102, 104, and 106 can be derived based on the reduction rules and parameters of the semantics.

To instantiate the common framework 100 to the particular modeling languages of the biological models 102, 104, and 106, the common interface 108 compiles a model of each modeling language into a set of chemical reactions by defining a species function and a reactions function for each modeling language. These definitions outline how the common interface 108 constructs the chemical reactions networks for the common framework 100. Generally, the species functions translate each of the biological models 102, 104, and 106 into a multiset of species Ī, and the reactions function generates the reactions between a new species I and the set of existing species Ĩ.

In one implementation, the species function translates a collection of molecules D into a canonical multiset of species, written species(D). A normal form for individual species I and a normal form for collections of molecules D are defined. All the species and molecules have a unique normal form. As such, species(D) may be computed by computing the normal form, normal(D) and discarding outermost defined new-quantified domains. The resulting parallel composition of species may then be converted into a multiset of species.

The reactions function computes the multiset of reactions between a new species and a set of existing species. The basic data structure for the common interface 108 is the simulator term for the simulator 110. The simulator term is a pair (Ī,Ō), where Ī is a finite multiset of species and Ō is a finite multiset of reactions between those species. Reactions O take the form (Ī₁,r,Ī₂), where the finite multiset Ī₁ is the reactants, the finite multiset Ī₂ is the products, and r is the rate of the reaction. The compilation of a language for one of the biological models 102, 104, or 106 is defined in terms of a reduction relation [symbol] _{σ}, where σ is the choice of semantic abstraction. Thus, the reactions function

reactions_{σ}(I,Ĩ′)Δunary_{σ}(I)+binary_{σ}(I,Ĩ′)

computes all the possible reactions between a new species I and the finite set of existing species Ĩ′ by separately computing all possible unary reactions for the species I and the set of all possible binary reactions between I and species from Ĩ′. The possible reactions are defined in terms of the semantic reduction relation of the modeling language with

unary_{σ}(I)Δ[([I],r,Ī′)|[I] [symbol] _{σ}Ī′]

and

binary_{σ}(I,Ĩ′)Δ[([I₁,I₂],r,Ī″)|I₂ ∈ Ĩ′;[I₁,I₂] [symbol] _{σ}Ī′.

Using the simulator term definition, the common framework 100 is instantiated with each modeling language of the biological models 102, 104, and 106.

In one implementation, the biological models 102, 104, and 106 are simulated in simulation 110 in saturating mode, wherein all possible reactions are enumerated in the initial compilation. There are no additional reactions that may be added during the simulation run by the common interface 108. During initial compilation, the reactions can potentially generate new species, which in turn generate new reactions. The simulator 110 continues generating reactions and species until no new species are generated. The simulator 110 then simulates these reactions given the initial species populations. The simulator 110 outputs the simulation results 114, which represent the time series plotting the populations of species over time, together with the set of all possible reactions that can potentially take place given the initial set of species, although other data may be provided as simulation results 112. The simulation results 112 may be presented in a graphical user interface, data readout, data stream, etc.

In another implementation, the biological models 102, 104, and 106 are simulated in simulation 110 in just-in-time compiler mode by instantiating the common framework 100 with a given simulation algorithm. The set of reactions that directly involve the initial species are computed, and the reactions involving the initial species together with the initial species populations are used to determine which reaction to select. The selected reaction is applied to the current set of species, resulting in some species being consumed and some new species being produced. The set of reactions involving the updated set of species is computed, and the next reaction is selected. A function next(T) is defined to select the next reaction from a term T, a function init(Õ,T) is defined for initializing a term with a set of reactions Õ, and a function updates(I,T) is defined for updating the reactions in a term affected by a given species I. The common interface 108 repeatedly executes the following rule during a simulation run by the simulator 110:

$$\frac{( \overline{I} , r , \overline{{I}^{′}} ) , a , {t}^{′} = next ( t , S , R )}{( t , S , R ) {\to }^{a , ( \overline{I} , r , \overline{{I}^{′}} )} \overline{{I}^{′}} + ( ( {t}^{′} , S , R ) - \overline{I} )} \qquad ( 1 )$$

where the machine term T consists of the current time t, a species map S and a reaction map R. Each time the next reaction is selected, the selected reaction is executed by removing the reactants Ī from the machine term, adding products Ī′, and updating the current time t of the machine. If a new species I is already present in the machine term, then its population is incremented in S and the activity of the affected reactions is updated. If the species is not already present in the machine term, its population is set to 1 in S and a new set of reactions for the species is computed, together with their activity. Species Ī may be removed from the machine term by decrementing the corresponding species populations and by updating the affected reactions. Accordingly, the compilation of reactions is interleaved with the simulation by the simulator 110. As such, even if the biological models 102, 104, and 106 generate a potentially unbounded number of species and reactions, the biological models 102, 104, and 106 may be simulated precisely. The simulator 110 outputs the simulation results 114, which is the time series plotting the populations of species over time during the particular simulation run, together with the set of reactions that took place during the simulation. The simulation results 114 may be presented in a graphical user interface, data readout, data stream, etc.

The common framework 100 can be used to simulate multiple modeling languages, such as the modeling languages associated with the biological models 102, 104, and 106, concurrently by assuming a separate species type I_{L}for each language L, together with an initial set of cross-language reactions Õ_{O}. For example, the cross-language reaction

I_{DSD}+I_{SPiM} [symbol] I_{SPiM}+I′_{SPiM}

takes a species of the DSD language of the DNA molecule model 102 together with a species of the SPiM language of the host immune system model 106 and produces a corresponding species in the SPiM language together with the original SPiM species. The example cross-species reaction enables the output of the DNA molecule model 102 to interface with the host immune system model 106. For each dynamically created species I_{L} the reactions function reactions(I_{L},Ĩ′) calls the appropriate language-specific reactions function reactions_{L}(I_{L},Ĩ_{L}′), where I_{L} denotes the subset of species in Ĩ′ that are of the type L. Accordingly, multiple languages may interact with each other within the common framework 100, via a fixed set of interface reactions given by the common interface 108.

Further, by decoupling the choice of modeling language from the choice of simulation method, multiple languages may re-use the same method via the common interface 108, without the need to implement custom simulation methods for each language. Accordingly, models of concurrent systems, such as the biological models 102, 104, and 106, may be constructed from components written in different domain-specific modeling languages, each designed to allow a natural, concise encoding of that component. The components may interact dynamically via the common interface 108, allowing integrated simulation of heterogeneous concurrent systems.

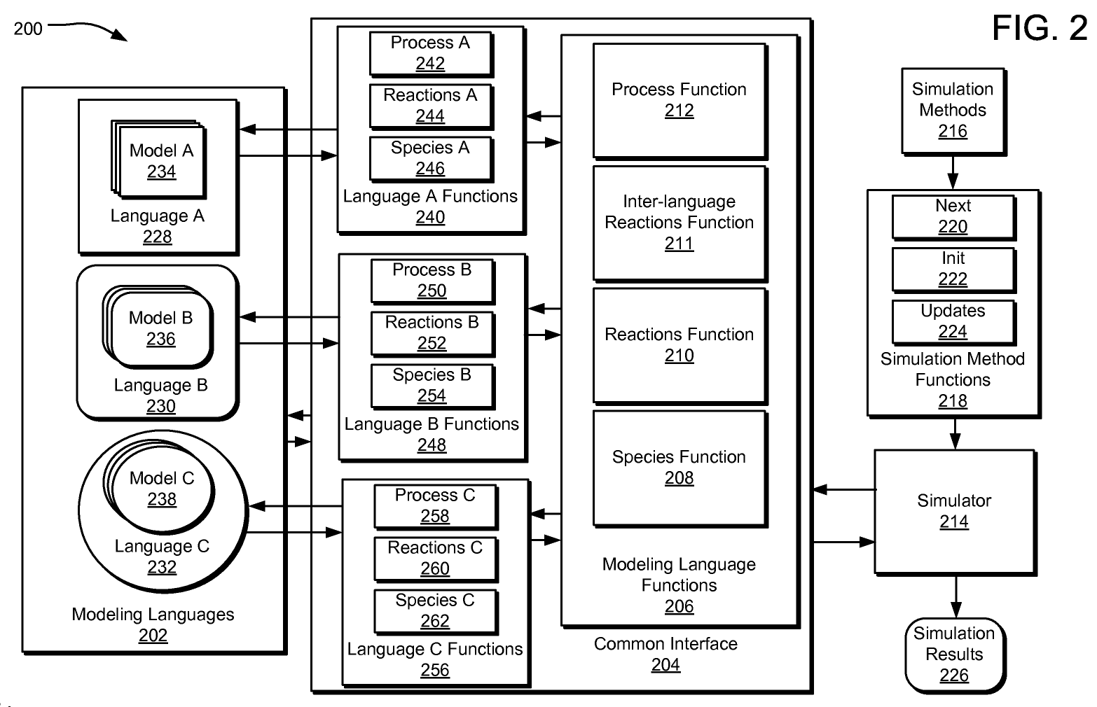

FIG. 2 illustrates an example common framework 200 for performing a stochastic simulation of multi-language models. The common framework 200 includes modeling languages 202 that are defined in terms of modeling language functions 206, which include a species function 208, a reactions function 210, and a process function 212. The species function 208 converts a model of the modeling languages 202 into a set of species, and the reactions function 210 computes a set of possible reactions between the species. The process function 212 translates a set of species into a model to prove the general correctness of the common framework 200.

A common interface 204 instantiates the common framework 200 to encode a range of modeling languages 202 and to use a range of stochastic simulation methods. The common framework 200 is instantiated to a particular simulation method 216 by defining simulation method functions 218, the next function 220, the init function 222, and the updates function 224. The simulator 214 uses the common interface 204 to dynamically update a set of possible reactions and choose the next reaction for a simulation run in an iterative cycle. The results of the simulation run in the simulator 214 are output as simulation results 226. The simulation results 226 may be presented in a graphical user interface, data readout, data stream, etc.

The common framework 200 may be instantiated to the modeling language 202 by defining the species function 208 and the reactions function 210. The species function 208 converts a model of the modeling languages 202 into a set of species, and the reactions function 210 computes a set of possible reactions between the species. The semantics of the modeling language 202 can be used to derive the corresponding reactions function 210.

The simulator 214 is defined by a formal syntax and semantics. The syntax of the simulator 214 includes a machine term T. The machine term T is a triple (t,S,R), where t is the current time, S is a map from a species I to its population I, and R is a map from a reaction O to its activity A, which is used to compute the next reaction. The data structure for the activity A depends on the selected simulation method 216. Each reaction is represented as a tuple (Ī,r,Ī′), where Ī denotes the multiset of reactant species, Ī′ denotes the multiset of product species, and r denotes the reaction rate. The syntax of species I is specific to modeling languages 202.

To instantiate the common framework 200 with the modeling language 202, the species function 208, species(P), transforms a model P of the modeling language 202 to a multiset of species. Accordingly, the species function is used to initialize the common framework 200 at the beginning of a simulation by the simulator 214. In contrast, the reactions function 210, reactions (I,Ĩ′), computes the multiset of reactions between a new species I and an existing set of species Ĩ\tilde{′}. Accordingly, the reactions function is used to update the set of possible reactions dynamically. In one example, the common framework 200 is instantiated with three different modeling languages, the stochastic pi-calculus, the bioambient calculus, and the kappa calculus by appropriately defining the species function 208 and the reactions function 210, although it should be understood that alternative modeling languages may be used. The stochastic pi-calculus is an example of an agent-based modeling language, where the behavior of an individual agent is described by a separate process. The instantiation of the stochastic pi-calculus is optimized so that multiple process complexes can be grouped together for improved efficiency. The bioambient calculus is an example of an agent-based language with compartments. The aspects of the instantiation that relate specifically to the movement of compartments relative to each other are the focus of the bioambient calculus. Finally, the kappa calculus is an example of a rule-based modeling language where the reactions among individual species are described as rules. The focus of the kappa calculus is the correspondence between rules and reactions. For each language, the semantics of the language itself is used to derive the corresponding reactions function.

To instantiate the common framework 200 with a particular simulation method 216, the simulation method functions 218 are provided. The next function 220, next(T), selects the next reaction from a machine term T. The init function 222, init(Ō,T), initializes a machine term T with a multiset of reactions Ō, and the updates function 224, updates(I,T), updates the activity of the reactions in a machine term T that are affected by a given species I. The simulation method 216 is executed by the common interface 204 by repeatedly applying the Equation (1). A reaction is selected using the next function 220, which returns the selected reaction, its activity a, and the new simulation time t′. The selected reaction executes to remove the reactants Ī, add the products Ī′, and update the current simulation time t in the machine term T.

A model of the modeling language 202 P is added to a machine term T by computing the multiset of species ī=[I₁, . . . , I_{N}] that correspond to P and then adding each of these species to the machine term T. If a new species I is already present in the machine term T, then its population is incremented in S and the activity of the affected reactions is updated. If the species is not already present in the machine term T, then its population is initialized in S and new reactions for the species are computed, together with their activity. Species Ī may be removed from the machine term T by decreasing the corresponding species populations and updating the activity of the affected reactions.

By defining the appropriate next function 220, the init function 222, and the updates function 224, the common framework 200 may be instantiated with a selected simulation method 216. For example, Gillespie's Direct Method, the Next Reaction Method, and a range of other stochastic simulation methods, including methods for handling both Markovian and non-Markovian rates concurrently, may be used.

In an implementation, Markovian simulation methods are used where the conditional probability distribution of future states of the modeling language 202 depends only upon the present state. For Markovian simulation methods in which all reaction rates r are assumed to be exponentially distributed of the form exp(λ), the Continuous Time Markov Chain (CTMC) of the common framework 200 may be computed. The CTMC semantics may be derived from the reduction relation T [symbol] T′ using the rule

$$\frac{a = ( {\sum }_{\{ b , O \vert T {\to }^{b , O} {T}^{′} \}} b ) > 0}{T {\to }^{a} {T}^{′}} .$$

The activities b of all reactions T [symbol] T′ that give rise to the same machine term T′ are summed The corresponding CTMC in which the transitions for a given term T are given by the set {T [symbol] T′}, for each distinct term T′, may then be derived.

In an implementation, the common framework 200 may allow multi-language (heterogeneous) models to be constructed from components written using multiple different modeling languages. Accordingly, the most appropriate domain-specific modeling language may be selected to formalize each different aspect of the common framework 200. In one implementation, the modeling language 202 includes a finite set of languages, a language A 228, a language B 230, and a language C 232. The language A 228, the language B 230, and the language C 232 are each the domain-specific language for the corresponding model A 234, model B 236, and model C 238, respectively. Additionally, the common interface 204 includes language A functions 240, language B functions 248, and language C functions 256, which include a species function and a reactions function for each of the languages 228, 230, and 232. The common framework 200 is instantiated to language A 228 by defining a reactions A function 244 and a species A function 246. Similarly, the common framework 200 is instantiated to language B 230 by defining a reactions B function 252 and a species B function 254. Finally, the common framework 200 is instantiated to language C 232 by defining a reactions C function 260 and a species C function 262.

The language A functions 240, the language B functions 248, and the language C functions 256 are output into the modeling language functions 206. The starting species for the species function 208 is given by the starting species in each individual language, from the species A function 246, the species B function 254, and the species C function 262. The reactions function 210 includes all possible reactions for a model of a given language 228, 230, or 232, and an inter-language reactions function 211 includes all possible reactions between models of different languages 228, 230, and 232. The reactions function 210 operates as an interface to link the various components, such as languages 228, 230, and 232 together. The inter-language reactions are defined initially and depend on the structure of a heterogeneous model, such as the common framework 200. Accordingly, the languages 228, 230, and 232 may be different domain-specific modeling languages and interact with each other across the boundaries of their respective species types through the inter-language reactions.

For example, the modeling languages 202 may be defined as C with P_{C} representing the models in the modeling language 202 and I_{C} for the corresponding species in the species function 208. The definition of reactions in the reactions function 210 as a tuple (Ī,r,Ī′) induces a type of reactions R_{C} in terms of the associated species type I_{C}. With P_{fin}(X) denoting the set of all finite subsets of X, the type of the species function 208 may be defined as

species_{C}: P_{C}→P_{fin}(I_{C}),

and the type of the reactions function 210 may be defined as

reactions_{C}: I_{C}→P_{fin}(I_{C})→P_{fin}(R_{C}).

The languages 228, 230, and 232 are included in the finite set of languages defined as C̅≡{C₁, . . . , Cₙ} with the models and species types for the modeling language 202, C, defined in terms of those for the individual languages. The species type is defined as

I _{C̅} [symbol] I_{C}_{₁}+ . . . +I_{C}_{ₙ},

and the models type is defined as

P _{C̅} [symbol] →P_{C}₁× . . . ×P_{C}ₙ×P_{fin}(R_{C})

The species for a given calculus from the modeling language 202 may be extracted from the multi-language species type. If Ĩ ∈ I _{C̅}, then π_{C}_{ᵢ}(Ĩ)={I|I ∈Ī; I ∈ I_{C}_{ᵢ}}, and it follows that π_{C}_{ᵢ}(Ĩ)∈ I_{C}_{ᵢ} for all i and that {π_{C}_{ᵢ}(Ĩ)|i ∈ {1, . . . , n}}. Accordingly, if P ∈ P _{C̅} stands for a multi-language model such that P≡(P_{C}_{₁}, . . . , P_{C}_{ₙ},G), where G is the specified cross-language (glue) reactions, then the species function 208 for the modeling language 202 may be defined as

species _{C̅}(P) [symbol] species_{C}_{₁}(P₁)+ . . . +species_{C}_{ₙ}(Pₙ),

and the reactions function 210 for the modeling language 202 may be defined as

reactions _{C̅}(I,Ĩ) [symbol] reactions_{C}_{ᵢ}(I,π_{C}_{ᵢ}(Ĩ))+glue(I,Ĩ,O) if I ∈ I_{C}_{ᵢ}

where the glue function is defined as

glue(I,Ĩ,G) [symbol] [O|O ∈ G; I ∈ reactants(O); reactants(O)⊂Ĩ∪{I}].

Accordingly, the inter-language reactions in the reactions function 210 are defined by the set G of glue reactions where the new species I is one of the reactants to ensure that each glue reaction is only added once. Each species I is only considered once by the common interface 204 during a simulation run, so each glue reaction will be added once.

In other implementations, the languages 228, 230, and 232 may each have heterogeneous modeling sub-languages whose species and reactions are computed recursively. Accordingly, hierarchical models may be defined, where the components each contain sub-components written using various different domain-specific languages, using a common implementation layer. As a result, larger concurrent systems may be modeled because these systems are generally inherently hierarchical and composed of many different types of functional units. Therefore, complex, heterogeneous and recursive models may be simulated in the same framework as simple single-language models.

The common framework 200 relies on the semantics of a collection of modeling languages and further confirms that the common framework 200 faithfully executes the rules in accordance with the rules of the modeling languages, with, the correct probabilities. The common interface 204 includes a process function 212 that performs a static check to confirm that a set of conditions is satisfied and the common framework 200 is correct. The languages 228, 230, and 232 each have a process function, process A function 242, process B function 250, and process C function 258 associated with it, respectively. The process functions 242, 250, and 258 operate similarly to the process function 212 as described below.

The correctness of the common framework 200 may be proven for modeling languages with Markovian rates. In one implementation, a generic proof of correctness is defined for the modeling language 202 with respect to the simulation method 216. The proof is parameterized by the modeling language functions 206, used to define the modeling language 202. To prove the correctness of the common framework 200 for simulation with Markovian rates, it is sufficient that the CTMC generated by the language semantics is the same as the one generated by the common interface 204. A function (P)ₜ encodes a model or process P in the modeling language 202 into a corresponding machine term T at a given simulation time t. A function [T] decodes a machine term T into a corresponding model in the modeling language 202. The process function 212 is defined by [T], which translates a multiset of species back into a model. The process function 212 operates as an inverse to the species function 208. The correctness of (P)ₜ is established by demonstrating a reduction equivalence between the modeling languages 202 and the simulator 214. It is sufficient to prove the correctness of the modeling languages 202 with respect to the Direct Method of the simulation method 216 because the Direct Method is equivalent to other, more optimized methods for simulation with Markovian rates, such as the Next Reaction Method. The correctness for the modeling languages 202 encodings may be proven correct for the CTMC semantics of the modeling languages 202 and the CTMC semantics of the simulation method 216. The correctness results for the stochastic pi-calculus, the bioambient calculus, and the kappa calculus may be proved for each language separately.

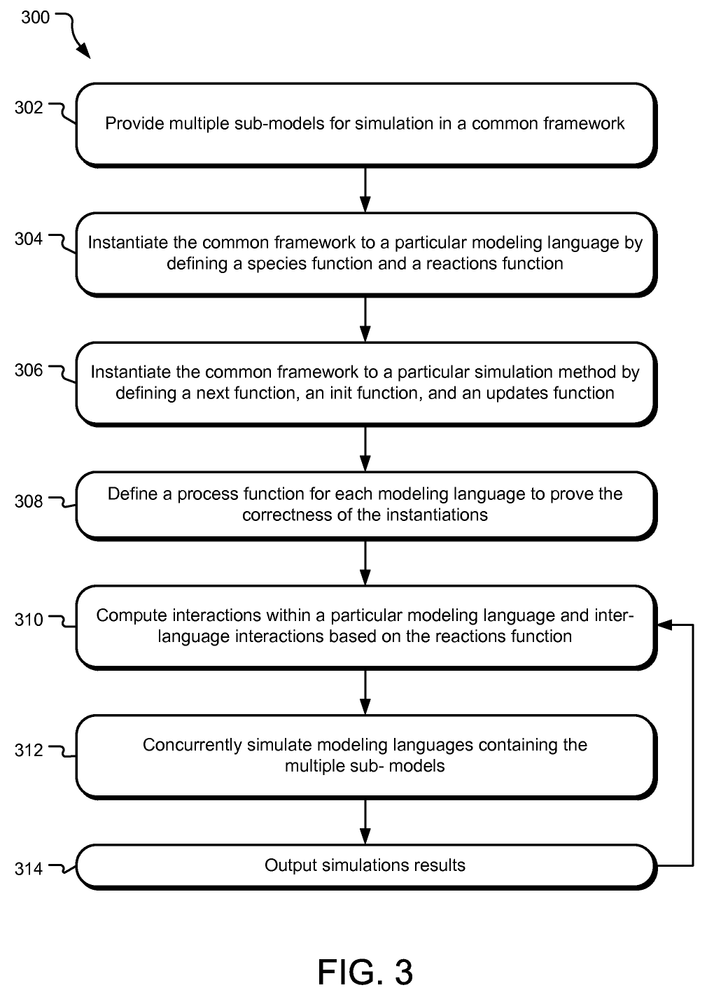

FIG. 3 illustrates example operations 300 for generating a multi-language environment for the simulation of heterogeneous models. A providing operation 302 identifies multiple sub-models for simulation in a common framework. The multiple sub-process models pertain to a concurrent system, and each sub-model pertains to a sub-system of the concurrent system. In one implementation, the sub-models are each written in different modeling languages. Each of the modeling languages may be, for example, the stochastic pi-calculus, the bioambient calculus, or the kappa calculus. The multiple sub-models interact according to a set of defined rules. The modeling languages each include syntax and semantics that may be used to define a species function and a reactions function for each of the modeling languages.

In an instantiation operation 304, a common framework is instantiated to a particular modeling language by defining a species function and a reactions function for each of the sub-models. The species function converts a model of each language into a set of species, and the reactions function computes a set of possible reactions between the species for each modeling language. Accordingly, one or more instances of each sub-model are instantiated, and each instance provides a reactions function and a species function that are compatible with a common interface. The semantics of the language itself is used to derive the corresponding reactions function. To derive the reactions function for the language, the language is defined by a formal syntax and semantics. To construct the basic syntax of a language, language constructs may be used to abstract away from the underlying processes that occur in a physical implementation. The semantics of a language formalize the various ways the components of the models can interact with each other by defining a set of reduction rules. The reduction rules are of the form

D [symbol] D′,

which states that a model D can reduce to a model D′ by performing a reaction with a finite rate r according to rule R. The reaction rules are used to define the reactions function for each instance. In one implementation, the instantiation operation 304 instantiates at least one heterogeneous model with inter-language reactions. The instance provides a reactions function that is compatible with the common interface of the one or more instances of each sub-model. The reactions function provided by the instance of the heterogeneous model is derived based on a set of possible inter-language reactions.

An instantiation operation 306 instantiates the common framework to a particular simulation method by defining a next function, and init function, and an updates function. The next function selects the next reaction, the init function computes the reaction activity from an initial set of reactions and species populations, and the updates function updates the reaction activity as the species populations change over time. The instantiation function 306 executes the simulation method by repeatedly applying the Equation (1).

By defining the appropriate next function, the init function, and the updates function, the common framework may be instantiated with a selected simulation method. For example, Gillespie's Direct Method, the Next Reaction Method, and a range of other stochastic simulation methods, including methods for handling both Markovian and non-Markovian rates concurrently, may be used.

In a defining operation 308, a process function is defined for each modeling language to prove the correctness of the instantiations from the instantiation operation 304 and the instantiation operation 306. Accordingly, the correctness of one or more sub-model instances and the heterogeneous model instance may be proven by defining a process function for each modeling language. In an implementation, the process function is defined initially to perform a static check to confirm that the common framework executes the rules of the one or more instances in accordance with the language semantics and with the correct probabilities. The process function translates a multiset of species back into a model. The process function operates as an inverse to the species function. The correctness for the modeling language encodings may be proven using the CTMC semantics of the modeling language and the CTMC semantics of the simulation method. The correctness results for the stochastic pi-calculus, the bioambient calculus, and the kappa calculus may be proved for each language separately.

A compute operation 310 computes reactions within a particular modeling language and inter-language reactions based on the reactions function. The species of each sub-model can only interact and produce species from that sub-model. As such, the inter-language reactions are the only way that species from different modeling languages can interact. To compute the reactions between a species and the set of existing species, the reactions function from each sub-model is used to compute all possible reactions within the associated language. The inter-language reactions are then computed by selecting a defined inter-language reaction where all the reactants are known and the new species is one of the reactants. The set of possible reactions is dynamically updated to select the next reaction in an iterative cycle.

A simulate operation 312 concurrently simulates multiple modeling languages containing the multiple sub-models. The simulation operation 312 processes the species function data and the reactions function data to allow the sub-models to interact. The compute operation 310 dynamically selects and updates the set of possible reactions, and the results are output in an output operation 314 in an iterative cycle until the simulation run is complete. In one implementation, the output operation 314 outputs the set of all possible reactions that can potentially take place given the initial set of species. The output operation 314 may present the simulation results in a graphical user interface, data readout, data stream, etc.

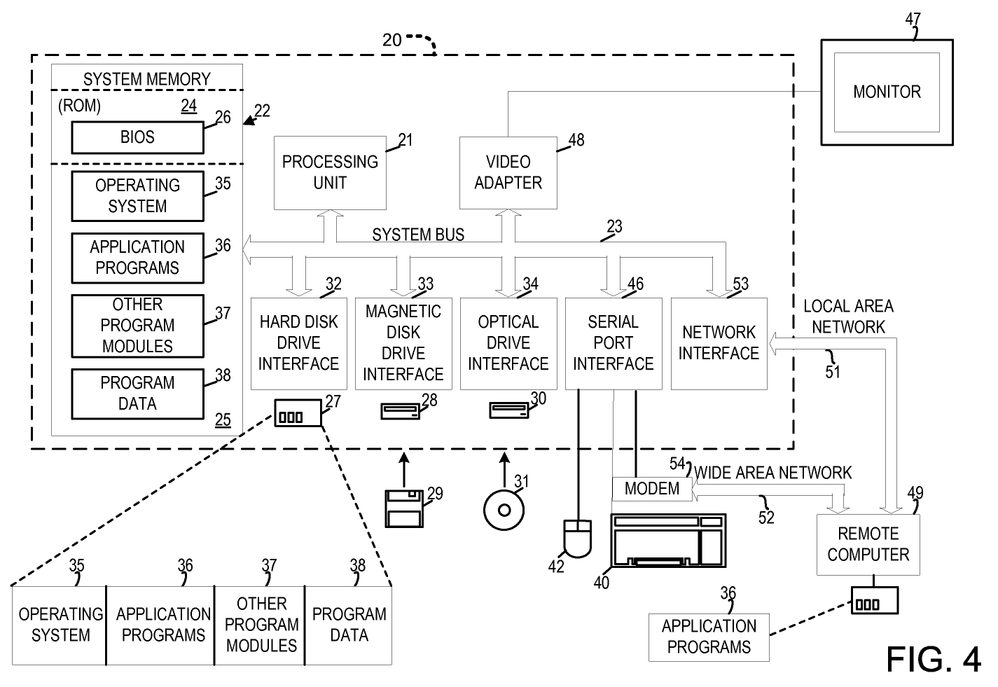

FIG. 4 illustrates an example system that may be useful in implementing the described technology. The example hardware and operating environment of FIG. 4 for implementing the described technology includes a computing device, such as general purpose computing device in the form of a gaming console or computer 20, a mobile telephone, a personal data assistant (PDA), a set top box, or other type of computing device. In the implementation of FIG. 4, for example, the computer 20 includes a processing unit 21, a system memory 22, and a system bus 23 that operatively couples various system components including the system memory to the processing unit 21. There may be only one or there may be more than one processing unit 21, such that the processor of computer 20 comprises a single central-processing unit (CPU), or a plurality of processing units, commonly referred to as a parallel processing environment. The computer 20 may be a conventional computer, a distributed computer, or any other type of computer; the invention is not so limited.

The system bus 23 may be any of several types of bus structures including a memory bus or memory controller, a peripheral bus, a switched fabric, point-to-point connections, and a local bus using any of a variety of bus architectures. The system memory may also be referred to as simply the memory, and includes read only memory (ROM) 24 and random access memory (RAM) 25. A basic input/output system (BIOS) 26, containing the basic routines that help to transfer information between elements within the computer 20, such as during start-up, is stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, a DVD, or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, random access memories (RAMs), read only memories (ROMs), and the like, may be used in the example operating environment.

A number of program modules may be stored on the hard disk, magnetic disk 29, optical disk 31, ROM 24, or RAM 25, including an operating system 35, one or more application programs 36, other program modules 37, and program data 38. A user may enter commands and information into the personal computer 20 through input devices such as a keyboard 40 and pointing device 42. Other input devices (not shown) may include a microphone, joystick, game pad, satellite dish, scanner, or the like. These and other input devices are often connected to the processing unit 21 through a serial port interface 46 that is coupled to the system bus, but may be connected by other interfaces, such as a parallel port, game port, or a universal serial bus (USB). A monitor 47 or other type of display device is also connected to the system bus 23 via an interface, such as a video adapter 48. In addition to the monitor, computers typically include other peripheral output devices (not shown), such as speakers and printers.

The computer 20 may operate in a networked environment using logical connections to one or more remote computers, such as remote computer 49. These logical connections are achieved by a communication device coupled to or a part of the computer 20; the invention is not limited to a particular type of communications device. The remote computer 49 may be another computer, a server, a router, a network PC, a client, a peer device or other common network node, and typically includes many or all of the elements described above relative to the computer 20, although only a memory storage device 60 has been illustrated in FIG. 4. The logical connections depicted in FIG. 13 include a local-area network (LAN) 51 and a wide-area network (WAN) 52. Such networking environments are commonplace in office networks, enterprise-wide computer networks, intranets and the Internet, which are all types of networks.

When used in a LAN-networking environment, the computer 20 is connected to the local network 51 through a network interface or adapter 53, which is one type of communications device. When used in a WAN-networking environment, the computer 20 typically includes a modem 54, a network adapter, a type of communications device, or any other type of communications device for establishing communications over the wide area network 52. The modem 54, which may be internal or external, is connected to the system bus 23 via the serial port interface 46. In a networked environment, program modules depicted relative to the personal computer 20, or portions thereof, may be stored in the remote memory storage device. It is appreciated that the network connections shown are example and other means of and communications devices for establishing a communications link between the computers may be used.

In an example implementation, modeling language module, common interface module, simulation methods module, species functions, reactions functions, and other modules and services may be embodied by instructions stored in memory 22 and/or storage devices 29 or 31 and processed by the processing unit 21. Modeling languages, instances of classes and other data may be stored in memory 22 and/or storage devices 29 or 31 as persistent datastores.

Some embodiments may comprise an article of manufacture. An article of manufacture may comprise a storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. In one embodiment, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language.

The embodiments of the invention described herein are implemented as logical steps in one or more computer systems. The logical operations of the present invention are implemented (1) as a sequence of processor-implemented steps executing in one or more computer systems and (2) as interconnected machine or circuit modules within one or more computer systems. The implementation is a matter of choice, dependent on the performance requirements of the computer system implementing the invention. Accordingly, the logical operations making up the embodiments of the invention described herein are referred to variously as operations, steps, objects, or modules. Furthermore, it should be understood that logical operations may be performed in any order, unless explicitly claimed otherwise or a specific order is inherently necessitated by the claim language.

Although the subject matter has been described in language specific to structure features and/or methodological acts, it is to be understood that the subject matter defined in the appended claims is not necessarily limited to the specific features or acts described above. Rather the specific features and acts described above are disclosed as example forms of implementing the claims.

The above specification, examples, and data provide a complete description of the structure and use of exemplary implementations of the described technology. Since many implementations can be made without departing from the spirit and scope of the described technology, the invention resides in the claims hereinafter appended. Furthermore, structural features of the different embodiments may be combined in yet another embodiment without departing from the recited claims.

What is claimed:

1. A method comprising:
receiving multiple models pertaining to a concurrent system, at least two of the models being written in different modeling languages;
instantiating the concurrent system, each modeling language of the multiple models of the concurrent system providing a species function compatible with a common interface and a reactions function compatible with the common interface, each species function being configured to compute a set of existing species from a model of the concurrent system, each reactions function being configured to compute a set of reactions between a new species and the set of existing species;
simulating the concurrent system stochastically and concurrently in a computing system by computing the set of reactions for each of the models; and
presenting results of the simulating operation.

2. The method of claim 1 further comprising:
receiving an inter-language reactions function compatible with the common interface, the inter-language reaction function being based on a set of possible inter-language reactions corresponding to at least two of the models written in different modeling languages.

3. The method of claim 1 further comprising:
generating feedback to the simulating operation by dynamically updating the set of reactions for each modeling language and by selecting a next reaction.

4. The method of claim 1 wherein the reactions function for each model is derived based on semantics of the corresponding modeling language.

5. The method of claim 1 wherein the instantiating operation comprises:
instantiating a selected simulation method in the concurrent system by defining a function for computing a next reaction, a function for computing reaction activity from an initial set of reactions and species populations, and a function for updating the reaction activity as the species population changes over time.

6. The method of claim 1 further comprising:
verifying correctness of the multiple models by defining a process function for each modeling language, each process function configured to translate a set of species into a model in the corresponding modeling language for comparison to an original model.

7. The method of claim 1 wherein the set of reactions includes a set of inter-language reactions.

8. One or more computer-readable storage media encoding computer-executable instructions for executing on a computer system a computer process, the computer process comprising:
receiving multiple models pertaining to a concurrent system, at least two of the models being written in different modeling languages;
instantiating the concurrent system, each modeling language of the multiple models of the concurrent system providing a reactions function compatible with a common interface, each reactions function configured to compute a set of reactions between a new species and a set of existing species;
simulating the concurrent system stochastically and concurrently in a computing system by computing the set of reactions for each of the models; and
presenting results of the simulating operation.

9. The one or more computer-readable storage media of claim 8 wherein the computer process further comprises:
receiving an inter-language reactions function compatible with the common interface, the inter-language reaction function being based on a set of possible inter-language reactions corresponding to at least two of the models written in different modeling languages.

10. The one or more computer-readable storage media of claim 8 wherein the computer process further comprises:
generating feedback to the simulating operation by dynamically updating the set of reactions for each modeling language and by selecting a next reaction.

11. The one or more computer-readable storage media of claim 8 wherein the reactions function for each model is derived based on semantics of the corresponding modeling language.

12. The one or more computer-readable storage media of claim 8 wherein the instantiating operation comprises:
instantiating a selected simulation method in the concurrent system by defining a function for computing a next reaction, a function for computing reaction activity from an initial set of reactions and species populations, and a function for updating the reaction activity as the species population changes over time.

13. The one or more computer-readable storage media of claim 8 wherein the computer process further comprises:
verifying correctness of the multiple models by defining a process function for each modeling language, each process function configured to translate a set of species into a model in the corresponding modeling language for comparison to an original model.

14. The one or more computer-readable storage media of claim 8 wherein each modeling language of the multiple models of the concurrent system further provides a species function compatible with the common interface, each species function being configured to compute the set of existing species from a model of the concurrent system.

15. A system comprising:
a common interface configured to receive multiple models pertaining to a concurrent system, at least two of the models being written in different modeling languages, the common interface further configured to instantiating the concurrent system, each modeling language of the multiple models of the concurrent system providing a reactions function compatible with a common interface, each reactions function configured to compute a set of reactions between a new species and a set of existing species;
a simulator configured to simulate the concurrent system stochastically and concurrently in a computing system by computing the set of reactions for each of the models; and
a presentation device configured to present results of the simulator.

16. The system of claim 15 wherein the common interface is further configured to receive an inter-language reactions function compatible with the common interface, the inter-language reaction function being based on a set of possible inter-language reactions corresponding to at least two of the models written in different modeling languages.

17. The system of claim 15 wherein the common interface is further configured to generate feedback to the simulator by dynamically updating the set of reactions for each modeling language and by selecting a next reaction.

18. The system of claim 15 wherein each modeling language of the multiple models of the concurrent system further provides a species function compatible with the common interface, each species function being configured to compute the set of existing species from a model of the concurrent system.

19. The system of claim 15 wherein the common interface is further configured to instantiate a selected simulation method in the concurrent system by defining a function for computing a next reaction, a function for computing reaction activity from an initial set of reactions and species populations, and a function for updating the reaction activity as the species population changes over time.

20. The system of claim 15 wherein the common interface is further configured to verify correctness of the multiple models by defining a process function for each modeling language, each process function configured to translate a set of species into a model in the corresponding modeling language for comparison to an original model.
